(19) United States
(12) Patent Application Publication
(10) Pub. No.: US 2017/0237275 A1
(43) Pub. Date: Aug. 17, 2017

(54) ELECTRICITY STORAGE DEVICE

(71) Applicant: PANASONIC INTELLECTUAL PROPERTY MANAGEMENT CO., LTD., Osaka (JP)

(72) Inventors: HIROSHI TENMYO, Osaka (JP); TAKASHI HASEGAWA, Osaka (JP); HIROSHI TAKASAKI, Osaka (JP); TAKESHI NAGAO, Osaka (JP)

(21) Appl. No.: 15/502,835

(22) PCT Filed: Jan. 15, 2016
(86) PCT No.: PCT/JP2016/000187

§ 371 Date: Feb. 9, 2017

(30) Foreign Application Priority Data
Jan. 26, 2015 (JP) 2015-011965

(51) Int. Cl. H02J 7/00; H01M 10/44; H01M 2/10

(52) U.S. Cl. CPC H02J 7/0068; H01M 2/1077; H01M 10/441; H02J 7/007; H01M 2220/10; H01M 2200/108

(57) ABSTRACT

An electricity storage device includes a battery, a discharge device, and a controller for controlling charging and discharging of the battery. The discharge device includes a swelling member, a movable switch, and a discharge switch. When the swelling member swells, the movable switch is moved. When the movable switch is moved, the discharge switch is turned on. A signal indicating that the discharge switch is turned on is transmitted to the controller to cause the battery to start discharging of electricity.

### TECHNICAL FIELD

The present disclosure relates to an electricity storage device.

### BACKGROUND ART

An assembled battery in which a plurality of batteries is coupled in parallel or in series to increase a charging capacity and an output voltage has been utilized as a power supply for driving a motor of an electric vehicle and other vehicles, or a home or industrial power supply.

### CITATION LIST

### Patent Literature

PTL 1: Unexamined Japanese Patent Publication No. 2010-182579

PTL 2: Unexamined Japanese Patent Publication No. 2011-115030

### SUMMARY OF THE INVENTION

### Technical Problem

When an old assembled battery is discarded, its electricity is fully discharged to ideally a terminal voltage of 0 V.

PTL 1 discloses a technique for fully discharging a secondary battery by means of an equalizing circuit that equalizes voltages of a plurality of secondary batteries. The equalizing circuit short-circuits electrodes of each of the plurality of secondary batteries.

PTL 2 discloses a forced discharge mechanism for causing a storage battery to spontaneously and automatically discharge electricity by allowing a liquid entered into an electricity storage device to move an electric resistor to conduct an electric power through conveying paths by means of the moved electric resistor. The forced discharge mechanism disclosed in PTL 2 is not intended to achieve a discharge process when discarding a storage battery, but is intended to function when a storage battery is submerged in water or the like because a vehicle is submerged or flown or a house is flooded due to a flood road or a flood caused by a river flood occurred under a recent abnormal weather condition.

Therefore, it is an object of the present disclosure to provide an electricity storage device capable of discharging energy from an assembled battery when discarding the assembled battery without requiring any artificial operations.

### Solution to Problem

An electricity storage device according to the present disclosure includes a battery, a discharge device, and a controller for controlling charging and discharging of the battery. The discharge device includes a swelling member, a movable switch, and a discharge switch. When the swelling member swells, the movable switch is moved. When the movable switch is moved, the discharge switch is turned on. A signal indicating that the discharge switch is turned on is transmitted to the controller to cause the battery to start discharging.

An electricity storage device according to the present disclosure includes a battery and a discharge device. The discharge device includes a swelling member, a movable conductive plate, a discharging positive electrode terminal, and a discharging negative electrode terminal. The discharging positive electrode terminal is electrically coupled to a positive electrode terminal of the battery. The discharging negative electrode terminal is electrically coupled to a negative electrode terminal of the battery. The conductive plate is moved when the swelling member swells to short-circuit the discharging positive electrode terminal and the discharging negative electrode terminal.

### Advantageous Effects of Invention

According to the present disclosure, an electricity storage device capable of discharging energy from an assembled battery when discarding the assembled battery without requiring any artificial operations can be provided.

### BRIEF DESCRIPTION OF DRAWINGS

FIG. 1 is a perspective view illustrating an appearance of an electricity storage device according to a first exemplary embodiment.

FIG. 2 is a side view illustrating another appearance of the electricity storage device according to the first exemplary embodiment.

FIG. 3 is a view for describing the electricity storage device.

FIG. 4 is a perspective view of a discharge device according to the first exemplary embodiment.

FIG. 5 shows views illustrating an internal structure of the discharge device according to first exemplary embodiment.

FIG. 6 is a perspective view illustrating an appearance of a case.

FIG. 7 shows views for describing the discharge device according to first exemplary embodiment.

FIG. 8 is a perspective view illustrating an appearance of an electricity storage device according to a second exemplary embodiment.

FIG. 9 is a side view illustrating another appearance of the electricity storage device according to the second exemplary embodiment.

FIG. 10 shows views illustrating an internal structure of the discharge device according to the second exemplary embodiment.

### DESCRIPTION OF EMBODIMENTS

Exemplary embodiments will now specifically be described with reference to the drawings. Some descriptions might be omitted for substantially identical configurations shown in the drawings to avoid duplication.

In the exemplary embodiments, an electricity storage device served as home or industrial power supply is described. In the exemplary embodiments, the electricity storage device is supposed to be used in everyday situations. In an aspect of use of the electricity storage device, for example, a battery is charged in a period of time during which an electric power charge is lower, and the battery supplies the charged electric power to a load in another period of time during which the electric power charge is higher.

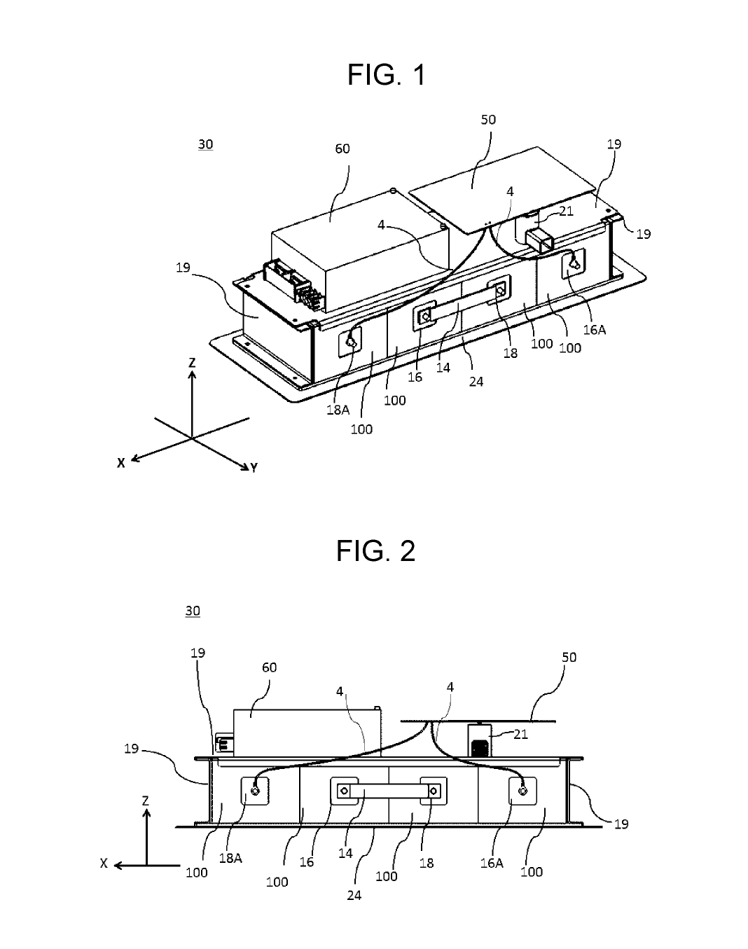

A first exemplary embodiment will now be described with reference to FIGS. 1 to 7.

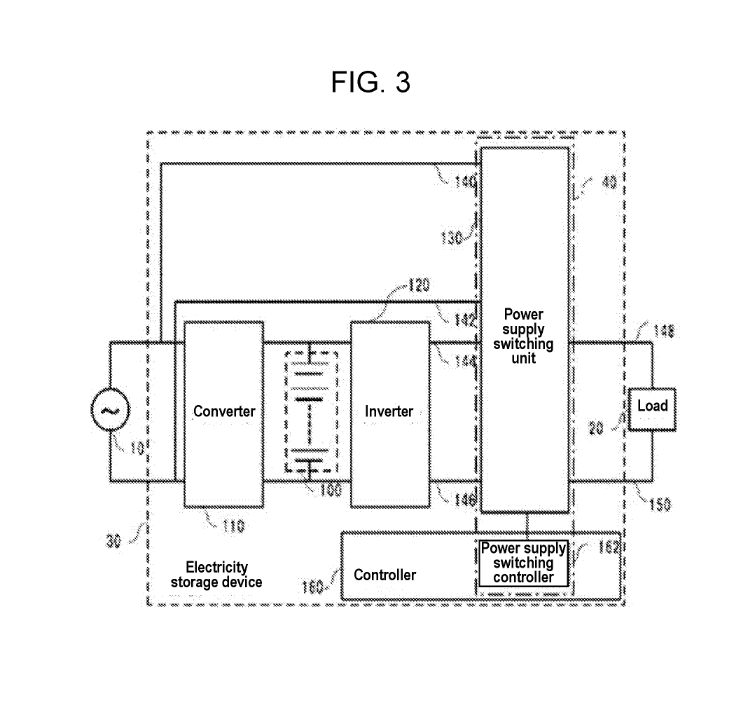

FIG. 1 is a perspective view illustrating an appearance of electricity storage device 30. A direction X, a direction Y, and a direction Z are defined based on a disposition direction of electricity storage device 30 shown in FIG. 1. FIG. 2 is a side view of electricity storage device 30, as viewed in the direction Y. FIG. 3 is a view for describing electricity storage device 30.

In the first exemplary embodiment, electricity storage device 30 is configured to include four battery blocks 100, and a control system for controlling charging and discharging of batteries included in battery blocks 100.

Battery blocks 100 are each configured to include, for example, an assembled battery in which a plurality of cylindrical batteries is electrically coupled in parallel. Positive electrode terminals 16 and negative electrode terminals 18 of adjacent battery blocks 100 are electrically coupled in series by bus bars 14. Fixing members 19 are provided on sides and a top of battery blocks 100. Fixing members 19 are fixed to bottom 24 of battery blocks 100.

Control board 50, voltage converter 60, and other components configure the control system for controlling charging and discharging of the batteries. Positive electrode terminal 16A and negative electrode terminal 18A are electrically coupled actually to load 20 and commercial AC power supply 10 via the control system. Signal lines 4 transmit information about the state of battery blocks 100 to controller 160.

Electricity storage device 30 includes discharge device 21. Discharge device 21 will be described later.

The control system will now briefly be described with reference to FIG. 3. Electricity storage device 30 is a possible system coupled to commercial AC power supply 10 to supply AC power to load 20. The control system includes converter 110, inverter 120, power supply switching unit 130, and controller 160. Converter 110 and inverter 120 are included in voltage converter 60.

Power supply switching unit 130, controller 160, and other components can be disposed on control board 50. The control system can be said to include power supply switching device 40 including power supply switching unit 130 and power supply switching controller 162.

Converter 110 follows an instruction from controller 160 to convert AC power supplied from commercial AC power supply 10 into DC power, and to supply the DC power to battery blocks 100 to charge battery blocks 100. Inverter 120 follows an instruction from controller 160 to cause battery blocks 100 to discharge electricity, and to convert DC power supplied from battery blocks 100 into AC power to supply the AC power to power supply switching unit 130.

Power supply switching unit 130 is supplied with AC power from commercial AC power supply 10 via line 140 and line 142. Power supply switching unit 130 is also supplied with AC power from inverter 120 via line 144 and line 146. In addition, power supply switching unit 130 follows an instruction from controller 160 to select AC power supplied from commercial AC power supply 10 or AC power supplied from inverter 120 to supply the AC power to load 20 via line 148 and line 150.

Controller 160 controls electricity storage device 30 entirely. Controller 160 controls conditions in battery blocks 100 such as states of charge (SOCs) and temperatures. Controller 160 further causes converter 110 to control charging, or causes inverter 120 to control discharging. In addition, controller 160 includes power supply switching controller 162. Power supply switching controller 162 controls power supply switching unit 130 to control for switching between AC power supplied from commercial AC power supply 10 and AC power supplied from inverter 120.

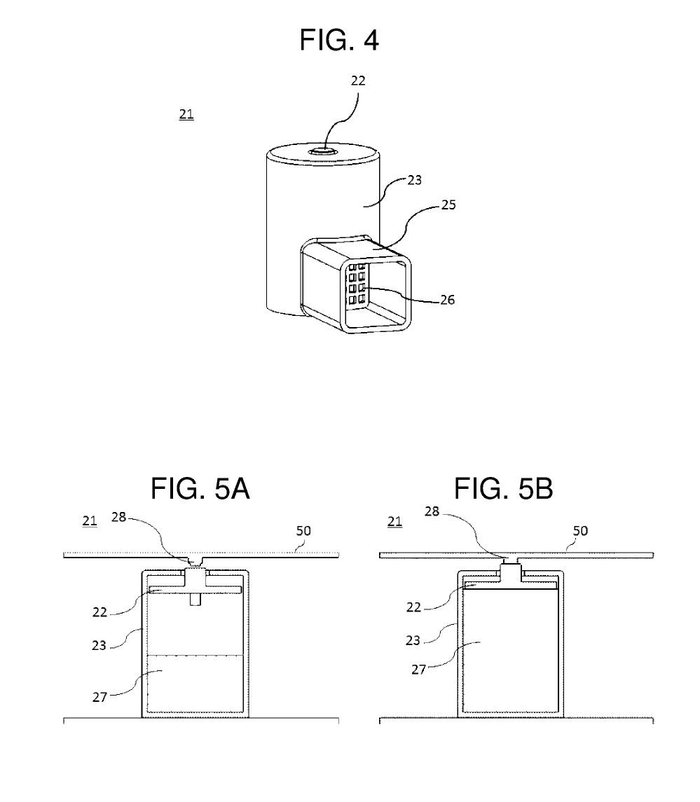

FIG. 4 is a perspective view of discharge device 21. FIG. 5 shows views illustrating an internal structure of discharge device 21, where FIG. 5(A) is a view illustrating electricity storage device 30 before discharging of electricity begins, and FIG. 5(B) is a view illustrating electricity storage device 30 after discharging of electricity begins.

A possible case when discharge device 21 discharges electricity from electricity storage device 30 is a case when electricity storage device 30 does neither charge nor discharge electricity for a long period of time. A possible case when electricity storage device 30 does neither charge nor discharge electricity for a long period of time is, for example, a case when electricity storage device 30 has not been used in order to discard electricity storage device 30. In such a case, it is preferable that a discharge process lower terminal voltages of the batteries included in electricity storage device 30 to 0 V for a safety reason.

Discharge device 21 is a switch for starting a discharge process for the batteries included in battery blocks 100. Discharge device 21 includes movable switch 22 and discharge switch 28. Movable switch 22 causes discharge switch 28 to be turned on. When discharge switch 28 is turned on, a discharge process begins for the batteries included in electricity storage device 30. Discharge switch 28 may be disposed on control board 50.

Inside housing 23, an appropriate amount of swelling member 27 is disposed. Discharge device 21 externally introduces moisture to cause swelling member 27 to swell with the introduced moisture. Swelled swelling member 27 moves movable switch 22, and movable switch 22 causes discharge switch 28 to be turned on.

Discharge device 21 includes moisture introduction port 25 and holes 26. Discharge device 21 externally introduces moisture into housing 23 via moisture introduction port 25 and holes 26. As long as moisture can be introduced externally, moisture introduction port 25 may be eliminated.

Swelling member 27 may be a mixture of a water absorbing polymer and a moisture absorbing agent such as calcium chloride. With an added water absorbing polymer, swelling member 27 swells. With an added moisture absorbing agent, the moisture absorbing agent retains moisture in air, and the water absorbing polymer absorbs moisture retained by the moisture absorbing agent, so that a speed at which the water absorbing polymer swells can be adjusted. The water absorbing polymer may be, for example, an acrylic acid polymer, polyvinyl alcohol, and polyethylene glycol.

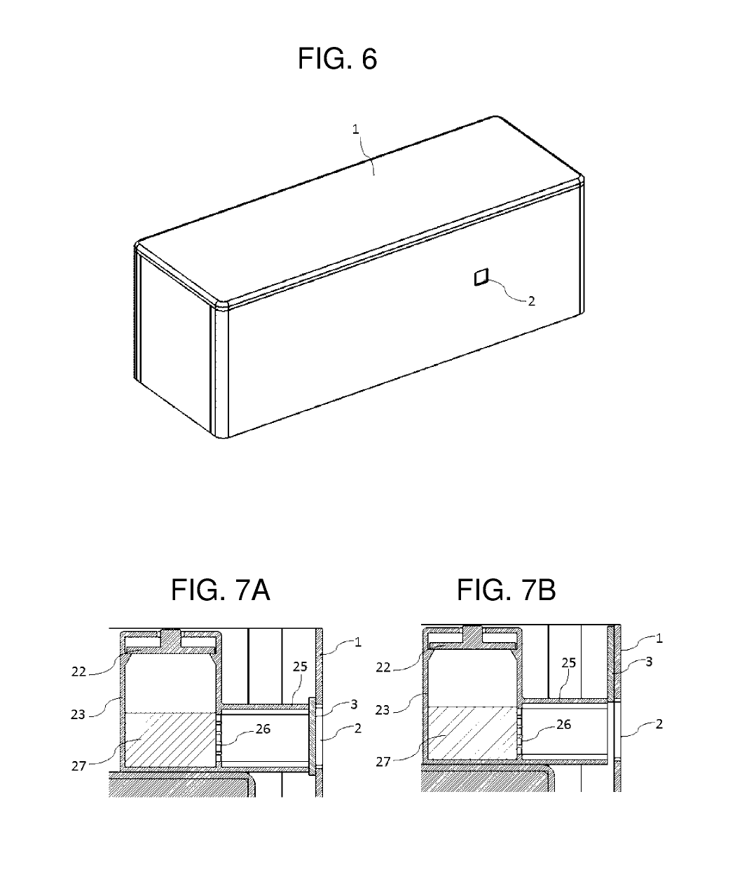

FIG. 6 is a perspective view illustrating an appearance of case 1 accommodating electricity storage device 30. FIG. 7(A) is a view illustrating a situation before moisture is externally introduced into discharge device 21. FIG. 7(B) is a view illustrating a situation when moisture is externally introduced into discharge device 21.

Electricity storage device 30 is accommodated in case 1. Case 1 includes opening 2 and lid 3 for introducing moisture in air from moisture introduction port 25 into discharge device 21. In accordance with an instruction from controller 160, lid 3 opens opening 2. Upon lid 3 opens opening 2, moisture is externally introduced from moisture introduction port 25 and holes 26, and thus swelling member 27 starts swelling. Case 1 includes an outlet port (not shown) for supplying electric power to load 20, a power supply plug (not shown) for charging the batteries included in electricity storage device 30 with commercial AC power supply 10, and other components.

A timing when opening 2 opens will now additionally be described herein.

Controller 160 controls opening 2 to open and close. Controller 160 is equipped with a timer. When controller 160 grasps from the signal lines 4 that the charging and discharging of electricity storage device 30 have stopped, the timer starts counting as a trigger that the charging and discharging of electricity storage device 30 have stopped. When a period during which the charging and discharging have stopped reaches a predetermined period, as a result of the counting by the timer, opening 2 opens.

The timer may preferably reset the counting if electricity storage device 30 restarts charging or discharging of electricity storage device 30 during the counting.

A user may set opening 2 to not open based upon user's operation when the user does not use electricity storage device 30 for a long period of time due to a travel or another reason, but the user then uses again electricity storage device 30. This control may be set such that the timer is reset each time electricity storage device 30 is operated again for a safety reason.

Behavior after discharge switch 28 is turned on will now be described herein.

When discharge switch 28 is turned on, a signal indicating that discharge switch 28 has been turned on is transmitted to controller 160. When controller 160 receives the signal indicating that discharge switch 28 has been turned on, controller 160 causes power supply switching controller 162 to switch power supply switching unit 130 so that AC power is supplied from inverter 120. The AC power supplied from inverter 120 is supplied to an internal load in electricity storage device 30, instead of an external load. An internal load includes, for example, starting electric power supplied to controller 160 and the like, and a special resistor provided in electricity storage device 30 for discharging.

AC power supplied from inverter 120 is electric power supplied from battery blocks 100. When electric power is supplied by inverter 120 to the internal load, a discharge process begins for the batteries included in electricity storage device 30 so that terminal voltages of the batteries included in electricity storage device 30 ideally lower to 0 V.

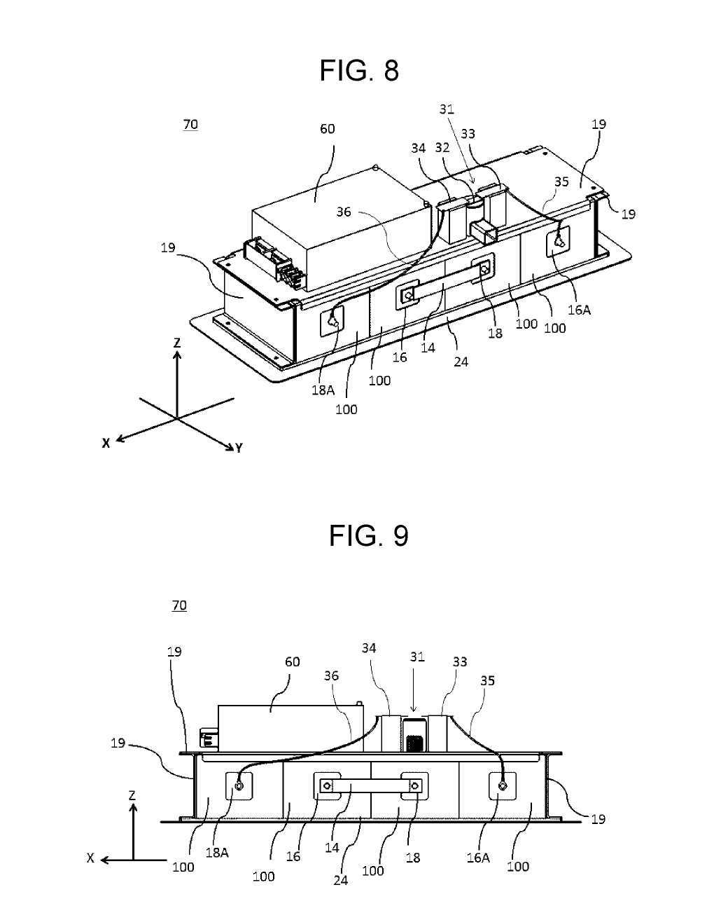

A second exemplary embodiment will now be described with reference to FIGS. 8 to 10.

In the first exemplary embodiment, controller 160 controls electricity storage device 30 for discharging. In the second exemplary embodiment, a mechanical configuration achieves discharging of electricity from electricity storage device 70.

In the second exemplary embodiment, different portions from the first exemplary embodiment are described.

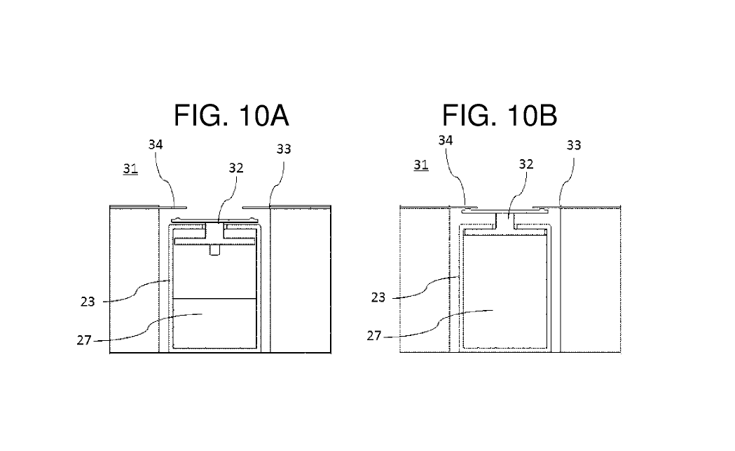

FIG. 8 is a perspective view illustrating an appearance of electricity storage device 70. A direction X, a direction Y, and a direction Z are defined based on a disposition direction of electricity storage device 70 shown in FIG. 8. FIG. 9 is a side view of electricity storage device 70 as viewed in the direction Y. FIG. 10 shows views illustrating an internal structure of discharge device 31, where FIG. 10(A) is a view illustrating electricity storage device 70 before discharging of electricity begins, and FIG. 10(B) is a view illustrating electricity storage device 70 after discharging of electricity begins.

In this exemplary embodiment, electricity storage device 70 is configured to include four battery blocks 100, and a control system for controlling charging and discharging of the batteries included in battery blocks 100.

A control board (not shown), voltage converter 60, and other components configure the control system for controlling charging and discharging of the batteries. Positive electrode terminal 16A and negative electrode terminal 18A are electrically coupled actually to load 20 and commercial AC power supply 10 via the control system.

Electricity storage device 70 includes discharge device 31. Discharge device 31 achieves a discharge process for the batteries included in battery blocks 100 with a mechanical configuration. Discharge device 31 includes movable conductive plate 32, discharging positive electrode terminal 33, and discharging negative electrode terminal 34. Discharging positive electrode terminal 33 is coupled, via power line 35, to positive electrode terminal 16A of four battery blocks 100 coupled in series. Discharging negative electrode terminal 34 is coupled, via power line 36, to negative electrode terminal 18A of four battery blocks 100 coupled in series. With conductive plate 32 electrically coupling positive electrode terminal 33 and negative electrode terminal 34, positive electrode terminal 33 and negative electrode terminal 34 short-circuit, and thus the batteries included in electricity storage device 70 discharge electricity. A resistor may preferably be provided for preventing heat from being generated excessively due to the short-circuiting. Conductive plate 32 may be configured to include a resistor.

Conductive plate 32 moves when swelling member 27 disposed in housing 23 of discharge device 31 swells. Discharge device 31 externally introduces moisture to cause swelling member 27 to swell with the introduced moisture. Swelled swelling member 27 moves conductive plate 32 to electrically couple positive electrode terminal 33 and negative electrode terminal 34.

Similarly to discharge device 21, discharge device 31 is accommodated in case 1. In case 1 accommodating discharge device 31, lid 3 provided to case 1 opens opening 2 in accordance with an instruction from controller 160. When lid 3 opens opening 2, moisture is externally taken in from moisture introduction port 25 and holes 26, and thus swelling member 27 of discharge device 31 swells.

Other configurations of discharge device 31 are identical to corresponding configurations of discharge device 21.

The first and second exemplary embodiments have exemplified electricity storage devices used as home or industrial power supplies. However, the discharge processes according to the present disclosure may be applicable to electricity storage devices served as power supplies for driving motors in electric vehicles or the like.

### INDUSTRIAL APPLICABILITY

An electricity storage device according to the present disclosure is useful for power supplies for driving motors in electric vehicles or the like, and for back-up power supplies or the like.

### REFERENCE MARKS IN THE DRAWINGS

1 case
2 opening
3 lid
4 signal line
10 commercial AC power supply
14 bus bar
16 and 16A positive electrode terminal
18 and 18A negative electrode terminal
19 fixing member
20 load
21 and 31 discharge device
22 movable switch
23 housing
25 moisture introduction port
26 hole
27 swelling member
28 discharge switch
30 and 70 electricity storage device
32 conductive plate
33 discharging positive electrode terminal
34 discharging negative electrode terminal
35 and 36 power line
40 power supply switching device
50 control board
60 voltage converter
100 battery block
110 converter
120 inverter
130 power supply switching unit
140 142 144 146 148 150 line
160 controller
162 power supply switching controller

1. An electricity storage device comprising:
a battery;
a discharge device; and
a controller for controlling charging and discharging of the battery,
wherein the discharge device includes a swelling member, a movable switch, and a discharge switch,
the movable switch is moved when the swelling member swells,
the discharge switch is turned on when the movable switch is moved, and
a signal indicating that the discharge switch is turned on is transmitted to the controller to cause the battery to start discharging.

2. An electricity storage device comprising:
a battery; and
a discharge device,
wherein the discharge device includes a swelling member, a movable conductive plate, a discharging positive electrode terminal, and a discharging negative electrode terminal,
the discharging positive electrode terminal is electrically coupled to a positive electrode terminal of the battery,
the discharging negative electrode terminal is electrically coupled to a negative electrode terminal of the battery,
the conductive plate is moved when the swelling member swells, and
the conductive plate short-circuits the discharging positive electrode terminal and the discharging negative electrode terminal.

3. The electricity storage device according to claim 1, wherein the swelling member includes a water absorbing polymer and a moisture absorbing agent.

4. The electricity storage device according to claim 1, wherein
the electricity storage device is accommodated in a case,
the case is provided with an opening and a lid for introducing moisture into the discharge device, and
the controller opens the lid to introduce the moisture from the opening.

5. The electricity storage device according to claim 2, wherein
the electricity storage device further includes a controller for controlling charging and discharging of the battery,
the case is provided with an opening and a lid for introducing moisture into the discharge device, and
the controller opens the lid to introduce the moisture from the opening.

6. The electricity storage device according to claim 4, wherein
the controller includes a timer,
the timer starts counting as a trigger that the charging and discharging of the battery stop, and continues counting until a period during which the charging and discharging of the battery stop reaches a predetermined period, and
the controller opens the opening when a count of the timer reaches the predetermined period.

7. The electricity storage device according to claim 2, wherein the swelling member includes a water absorbing polymer and a moisture absorbing agent.

8. The electricity storage device according to claim 5, wherein
the controller includes a timer,
the timer starts counting as a trigger that the charging and discharging of the battery stop, and continues counting until a period during which the charging and discharging of the battery stop reaches a predetermined period, and
the controller opens the opening when a count of the timer reaches the predetermined period.
